(19) United States
(12) Patent Application Publication
(10) Pub. No.: US 2007/0129058 A1
(43) Pub. Date: Jun. 7, 2007

(54) Memory management system and method for camera-equipped mobile communication devices

(75) Inventors: Assaf Landschaft, Munich (DE); Shajith Thengummootil, Bangalore (IN)

Correspondence Address: HITT GAINES, PC;AGERE SYSTEMS INC., PO BOX 832570, RICHARDSON, TX, 75083, US

(73) Assignee: Agere Systems Incorporated, Allentown, PA (US)

(21) Appl. No.: 11/291,646

(22) Filed: Dec. 1, 2005

(51) Int. Cl. H04L 12/58

(52) U.S. Cl. 455/412.1

(57) ABSTRACT

A mobile communication device and a method of memory management for the same. In one embodiment, the mobile communication device includes: (1) a camera, (2) a memory unit coupled to the camera and configured to store captured image data and (3) a transmitter coupled to the memory unit and configured to transmit captured image data via a wireless network to a receiving device, the mobile communication device configured to automatically adjust available storage space on the memory unit by transmitting selected digital image data stored in the memory unit to a receiving device and deleting the selected digital image data from the memory unit.

### TECHNICAL FIELD OF THE INVENTION

The present invention is directed, in general, to mobile communication devices and, more particularly, to a memory management system and method for camera-equipped mobile communication devices.

### BACKGROUND OF THE INVENTION

Today, many mobile communication devices are equipped with cameras and are widely used in lieu of dedicated digital cameras. For this reason, many such mobile communication devices are provided with a memory unit for storing captured images or video sequences.

Such memory units can be designed as integrated units or as replaceable memory cards, such as flash memory cards. For example, mobile telephone devices including a digital camera module for capturing digital images and a memory card for storing digital images are known.

Conventional memory management with today's mobile communication devices can be frustrating. When the memory unit of a mobile communication device is full, the user cannot continue the capturing of images or video sequences until at least some memory space is freed up again. This typically is performed by uploading image data to a personal computer (PC) and then deleting the images or video sequences from the memory unit. If the memory unit takes the form of a replaceable memory card, the full card can alternatively be replaced with a fresh, empty one. However, it is not possible to continue taking pictures without having to replace the memory card. Unfortunately, a spare memory card is not always available and can easily be forgotten. Of course, memory cards, either full or empty, are always subject to being lost.

Accordingly, what is needed in the art is a better memory management system and method for camera-equipped mobile communication devices. What is further needed in the art is a better way to secure image data as against unintentional loss.

### SUMMARY OF THE INVENTION

To address the above-discussed deficiencies of the prior art, the present invention provides, in one aspect, a mobile communication device. In one embodiment, the mobile communication device includes: (1) a camera, (2) a memory unit coupled to the camera and configured to store captured image data and (3) a transmitter coupled to the memory unit and configured to transmit captured image data via a wireless network to a receiving device, the mobile communication device configured to automatically adjust available storage space on the memory unit by transmitting selected digital image data stored in the memory unit to a receiving device and deleting the selected digital image data from the memory unit.

In another aspect, the present invention provides a method of memory management for a mobile communication device having a camera and a memory unit for storing captured image data. In one embodiment, the method includes: (1) wirelessly transmitting selected digital image data stored in the memory unit to a receiving device and (2) subsequently automatically deleting the selected digital image data from the memory unit.

The foregoing has outlined preferred and alternative features of the present invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a schematic view of one embodiment of a camera-equipped mobile communication device containing a memory management system or method constructed or carried out in accordance with the principles of the present invention;

FIG. 2 illustrates a block diagram of the mobile communication device of FIG. 1 showing, in particular, components of one embodiment of a memory management system constructed in accordance with the principles of the present invention;

FIG. 3 schematically illustrates two exemplary transmission paths to two exemplary receiving devices; and

FIG. 4 illustrates a flow diagram of one embodiment of a memory management method carried out in accordance with the principles of the present invention.

### DETAILED DESCRIPTION

Described herein is one aspect of the present invention that takes the form of a mobile communication device. The mobile communication device includes a camera, a memory unit configured to store captured image data and a transmitter configured to transmit captured image data via a wireless network to a receiving device. The mobile communication device is capable of automatic adjustment of available storage space on the memory unit. The automatic adjustment includes automatically transmitting selected digital image data stored in the memory unit to a receiving device and deleting the selected digital image data from the memory unit.

The invention is not limited to a certain type of mobile communication device, but encompasses mobile telephones, personal digital assistants (PDAs) or mobile digital assistants (MDAs) style devices, as well as any other conventional or later-developed mobile communication devices. The memory unit may be integrated in the mobile communication device or may take the form of an exchangeable memory card, such as, for example, a flash memory card. Examples of conventional flash memory cards include Compact Flash, Type I or II, Smart Media and Multimedia Cards. Of course, the present invention encompasses all conventional or later-discovered volatile or non-volatile memory cards.

The mobile communication device may further include a status detector. The status detector is configured to detect a value that is a measure for the part of the memory unit used for storing image data. In such case, the automatic adjustment includes detecting a value with the status detector and transmitting selected digital image data stored in the memory unit to a receiving device and deleting the selected digital image data from the memory unit in response to detecting a value that exceeds a threshold value, which may or may not be user-defined.

The mobile communication device may be configured to repeatedly perform the automatic adjustment of available storage space until it detects a value with the status detector that does not exceed the threshold value.

The mobile communication device may be further provided with a timer and configured to store a timer value representing a time interval and to perform the automatic adjustment of available storage space repeatedly in the time interval. The time interval may or may not be user-defined.

To perform the automatic adjustment of available storage space after each process of capturing and storing image data, the memory adjustment routine may be triggered after each such capturing process.

Furthermore, the mobile communication device advantageously is provided with a Man-Machine Interface (MMI), including, for example, a keypad and a display, and configured to perform the automatic adjustment of available storage space in response to user input.

The above-described status detector may be configured either to detect the fraction of the capacity of the memory unit that is presently used or that is presently available for storing image data. The status detector may also be configured to detect the number of images stored in the memory unit.

Essential for freeing memory space without losing the captured image data is the transmission of captured data to a receiving device prior to deleting the data. The mobile communication device therefore includes a transmitter configured to transmit captured image data. In particular embodiments, the transmitter is configured to transmit the data as part of an e-mail message, as part of a multimedia message according to Multimedia Messaging System (MMS) standards or via a web service on the Internet that allows images to be uploaded. For the latter, the mobile communication device should be capable of establishing a General Packet Radio Service/Wideband Code Division Multiple Access/Enhanced Data Rates for Global Evolution (GPRS/WEDGE) connection.

It may be desirable to transmit and delete the oldest of the stored captured data so the most recently captured data remains available. Therefore, in some embodiments, the mobile communication device is configured to store the capture time of captured images and video sequences together with the captured image data in the memory unit. The digital image data to be transmitted and deleted can then be selected on the basis of capture time, with the earliest capture time being particularly advantageous.

A mobile communication device equipped with a camera typically is also provided with one or more application programming interfaces (APIs) for controlling the camera. Also, the mobile communication device typically is provided with APIs for sending image data over existing wireless telecommunications networks, e.g., the Global System (for) Mobile (Communications)/GPRS (GSM/GPRS) or Universal Mobile Telephone Service (UMTS) network, depending on the type of device, and in particular for sending multimedia messages or e-mail messages including digital image data or GPRS/WEDGE for uploading to a web service. Furthermore, existing devices already are configured to detect the present status of an integrated memory unit. Therefore, embodiments of the present invention may be implemented in a straightforward way by means of a software by using existing APIs.

Thus, embodiments of the present invention may take the form of software or firmware composed of electronically readable control instructions stored and executed in the mobile communication device or dedicated hardware located in the mobile communication device. The software or firmware may be stored in a digital storage medium, in particular a chip, configured to be associated with the mobile communication device to cause it to perform one or more of the methods described herein.

Also described herein is another aspect of the present invention that takes the form of a method for memory management of a mobile communication device equipped with a camera and a memory unit for storing captured image data. The method includes a memory adjustment routine including the steps of transmitting selected digital image data stored in the memory unit to a receiving device and deleting the selected digital image data from the memory unit. The mobile communication device may perform the memory adjustment routine automatically.

The method has the potential to extend, perhaps significantly, the number of digital images or video sequences the user of a mobile communication device can capture without having to take conscious steps to free memory space on the mobile communication device's memory unit.

Reference to a memory adjustment routine in the following is defined to include transmitting selected stored digital image data to a receiving device and deleting the selected digital image data from the memory unit with or without prior detection of the present memory status. The memory adjustment routine may be performed whenever needed to provide sufficient memory space for a new process of capturing and storing image data. The amount of memory space needed can vary, for instance, depending on a user-selected setting concerning the resolution of digital images to be captured.

To assess whether a memory adjustment is needed, preferably a threshold value for the used space of the mobile communication device's memory unit is defined, perhaps by the user. Accordingly, the memory adjustment routine advantageously further includes detecting a value that is a measure for the part of the memory unit presently used for storing image data. The transmitting of selected stored image data and subsequent deletion of these data may thus be performed only if the detected value exceeds the threshold value. The memory adjustment routine may be performed repeatedly until the detected value falls below the threshold value.

For automatically performing the inventive memory adjustment in the background, i.e., without the need for actions by the user, the memory adjustment routine may be automatically repeated in time intervals, which may be user-defined.

Since additional memory space of the memory unit is typically occupied by capturing and storing image data, it may be advantageous to perform the memory adjustment routine automatically after each process of capturing and storing image data performed by the user. Memory space may therefore be automatically freed while taking pictures or videos, i.e., while capturing digital image data.

Alternatively, the memory adjustment routine may be performed in response to a user request, for instance by selecting an according menu entry of an MMI integrated in the mobile communication device. In this alternative embodiment, a message may be displayed for the user informing him that a pre-defined threshold value of used memory space is reached, giving the user the opportunity consciously to decide whether a memory adjustment routine should be performed.

The value that represents the part of the memory unit presently used for storing image data may be measured in different ways. The value may be the fraction of the capacity of the memory unit presently used for storing image data. Alternatively, the value may be the fraction of the capacity of the memory unit presently available for storing image data. The value may be the number of images stored in the memory unit, which is particularly advantageous if the digital images being captured and stored are of fixed file size. Of course, any basis for deriving the value falls within the scope of the present invention.

The step of transmitting selected digital image data may include automatically creating a multimedia message according to MMS standards including the selected digital image data and automatically sending the multimedia message to a pre-defined wireless receiving device. The receiving device may be, for example, a PC provided with a wireless network and a hard disk with a relatively large storage capacity.

Another suitable alternative for transmitting the selected image data includes automatically generating an e-mail message to which the selected digital image data is attached and automatically sending the e-mail message to a pre-defined e-mail address.

Yet another suitable alternative for transmitting the selected image data includes uploading the data to a web service on the Internet that allows images to be uploaded. Of course, any other conventional or future transmission format falls within the scope of the present invention.

The selection of which of the stored image data is to be transmitted and subsequently deleted from the memory unit of the mobile communication device may be performed in different ways. A straightforward way may be to select the first file in a list of stored files. If the user is interested in keeping the most recent images or video sequences on his device (which may often be the case), the method may include storing the capture time of captured images or video sequences together with the captured image data. In this way, the capture time may form a basis for the memory adjustment routine. For example, the digital image data to be transmitted and subsequently deleted may be the oldest captured data, i.e., the image data of the image or video sequence having the earliest capture time.

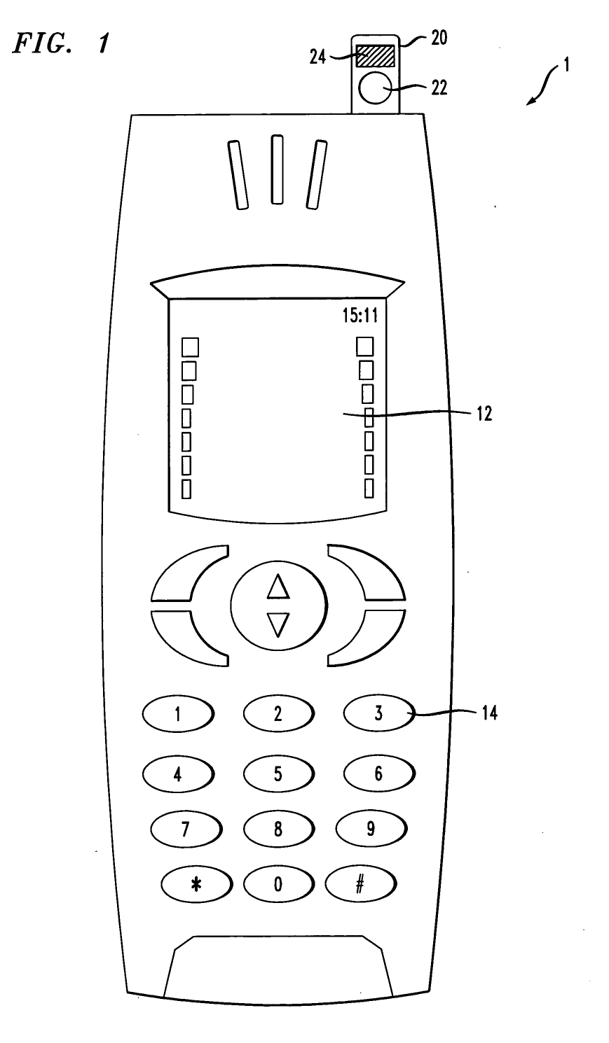

Having described a number of aspects and embodiments of the present invention, reference will now be made to the accompanying FIGUREs for further detail. Accordingly, FIG. 1 illustrates a schematic view of one embodiment of a camera-equipped mobile communication device containing a memory management system or method constructed or carried out in accordance with the principles of the present invention. A mobile telephone 1 is equipped with a camera 20 and a user interface including display 12 and keypad 14. In this embodiment, the camera 20 is provided with a lens 22 and a flash strobe 24.

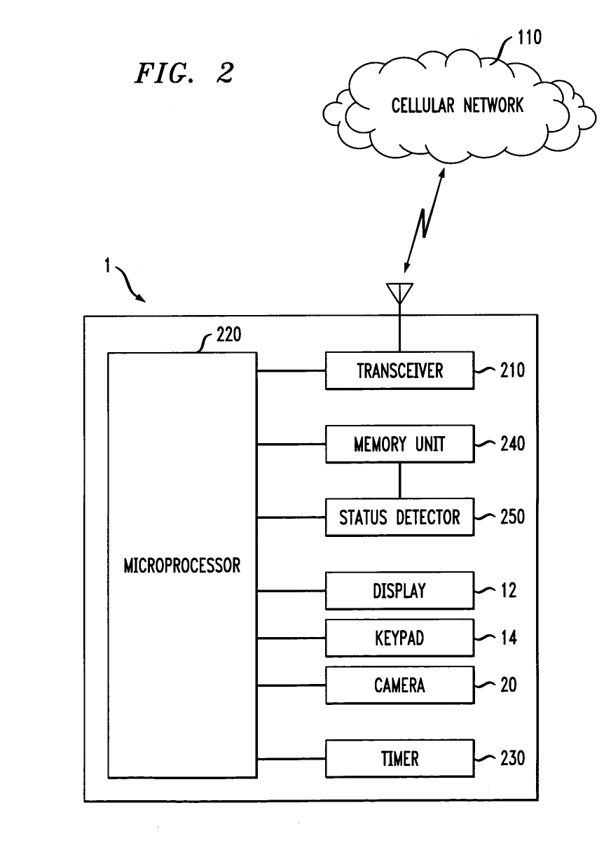

Turning now to FIG. 2, illustrated is a block diagram of the mobile communication device of FIG. 1 showing, in particular, components of one embodiment of a memory management system constructed in accordance with the principles of the present invention. The mobile telephone 1 includes a microprocessor as central controller. Image data captured with the camera 20 is stored in a memory unit 240, which can be provided as an embedded flash file system or an exchangeable memory card. As described above, any suitable memory card can be utilized. A status detector 250 is provided. The status detector 250 is configured to detect the available memory space on the memory unit 240. Furthermore, a timer 230 is provided. The timer 230 is configured to determine the capture time of captured image data, which in the illustrated embodiment, is stored along with the captured data. The user of the mobile telephone 1 can define a threshold value for the used memory space by means of keypad 14 and display 12.

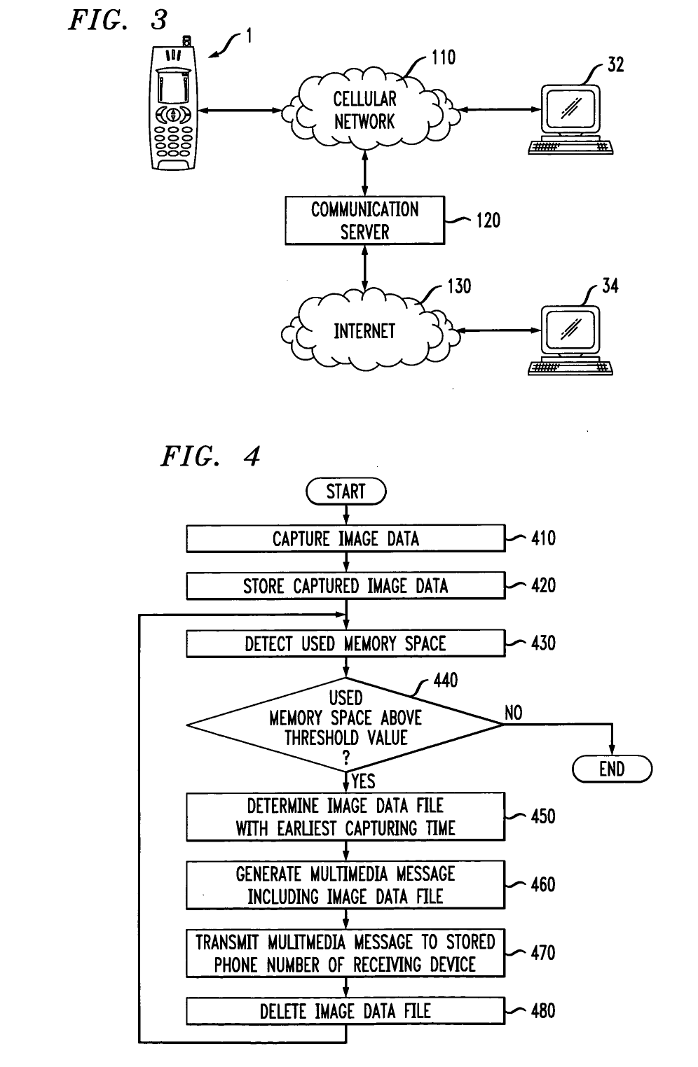

When an available memory space of the memory unit 240 is detected by the status detector 250 which exceeds the user-defined threshold value, the oldest image data file stored in memory unit 240 is automatically selected and transmitted to a receiving device (not shown in FIG. 2, but shown in FIG. 3) via the cellular network 110 by means of a transceiver 210. After the transceiver 210 successfully transmits the selected image data file, the selected image data file is automatically deleted from the memory unit 240 to free memory space. Detection of the present memory status can be triggered for instance in predefined time intervals by means of the timer 230 or after each process of capturing and storing new image data.

Turning now to FIG. 3, illustrated is a communication network via which image data can be transmitted from the mobile telephone 1 to one or both of exemplary receiving devices 32, 34. In one embodiment, the selected image data file is transmitted by means of MMS via the cellular network 110 to the receiving device 32, the receiving device 32 perhaps being a conventional PC equipped with a wireless network interface. In another embodiment, the selected image data file is transmitted by means of an e-mail message via the cellular network 110, the communication server 120 and the Internet 130 to the receiving device 34, perhaps being a conventional PC connectable to the Internet 130. In yet another embodiment, the selected image data file is uploaded to a web service via the cellular network 110, the communication server 120 and the Internet 130 to the receiving device 34, perhaps being a web server connectable to the Internet 130.

Turning now to FIG. 4, illustrated is a flow diagram of one embodiment of a memory management method carried out in accordance with the principles of the present invention. A memory adjustment routine is automatically triggered upon capturing (in a step 410) image data and storing (in a step 420) the captured image data in the memory unit 240 of FIG. 2. First, the present memory status is determined by detecting (in a step 430) the amount of memory space presently used for storing image data. The detected value for the used memory space is then compared (in a step 440) with a threshold value defined by the user. If the detected value does not exceed the threshold value, no further action is taken, and the method ends as indicated.

If, however, the detected value lies above the threshold value, the oldest stored image data file, i.e., the one having the earliest corresponding capturing date, is automatically determined (in a step 450). A multimedia message is automatically created (in a step 460) from the determined image data file and transmitted (in a step 470) to a receiving device, the receiving device is identified by, e.g., a telephone number or e-mail address. After successful transmission, the determined image data file is automatically deleted (in a step 480) from the memory unit 240 of FIG. 2. As described above, the steps 430, 440, 450, 460, 470, 480 may be repeated until a value for the used memory space is detected which is below the threshold value.

Although the present invention has been described in detail, those skilled in the pertinent art should understand that they can make various changes, substitutions and alterations herein without departing from the spirit and scope of the invention in its broadest form.

What is claimed is:

1. A mobile communication device, comprising:
a camera;
a memory unit coupled to said camera and configured to store captured image data; and
a transmitter coupled to said memory unit and configured to transmit captured image data via a wireless network to a receiving device, said mobile communication device configured to automatically adjust available storage space on said memory unit by transmitting selected digital image data stored in said memory unit to a receiving device and deleting said selected digital image data from said memory unit.

2. The mobile communication device as recited in claim 1 further comprising:
a status detector configured to detect a value representing a part of said memory unit used for storing image data, said mobile communication device configured to perform said transmitting and said deleting when said value exceeds a threshold value.

3. The mobile communication device as recited in claim 1 wherein said threshold value is user-defined.

4. The mobile communication device as recited in claim 2 wherein said mobile communication device is configured to repeatedly perform said automatic adjustment of available storage space until said value representing said part of said memory unit used for storing image data falls below said user-defined threshold value.

5. The mobile communication device as recited in claim 4 wherein said threshold value is user-defined.

6. The mobile communication device as recited in claim 1 wherein said mobile communication device is configured to store a timer value representing a time interval and to perform said automatic adjustment of available storage space repeatedly in said time interval.

7. The mobile communication device as recited in claim 6 wherein said time interval is user-defined.

8. The mobile communication device as recited in claim 1 wherein said mobile communication device is configured to perform said automatic adjustment of available storage space each time image data is captured and stored.

9. The mobile communication device as recited in claim 1 wherein said mobile communication device is configured to perform said automatic adjustment of available storage space in response to user input.

10. The mobile communication device as recited in claim 2 wherein said detected value is a fraction of a capacity of said memory unit presently used for storing image data.

11. The mobile communication device as recited in claim 2 wherein said detected value is a fraction of a capacity of said memory unit presently available for storing image data.

12. The mobile communication device as recited in claim 2 wherein said detected value is a number of images stored in said memory unit.

13. The mobile communication device as recited in claim 1 wherein said means for transmitting captured image data is configured to transmit captured image data as part of a selected one of:
an MMS-standard multimedia message,
an e-mail message, and
an upload to a web service.

14. The mobile communication device as recited in claim 1 wherein said mobile communication device is configured to store a capture time together with said captured image data in said memory unit and select said selected digital image data based on said capture time.

15. A method of memory management for a mobile communication device having a camera and a memory unit for storing captured image data, comprising:
wirelessly transmitting selected digital image data stored in said memory unit to a receiving device; and
subsequently automatically deleting said selected digital image data from said memory unit.

16. The method as recited in claim 15 further comprising detecting a value which is a measure for said part of said memory unit used, for storing image data and said wirelessly transmitting and said subsequently automatically deleting are performed only when said detected value exceeds a threshold value.

17. The method as recited in claim 16 wherein said threshold value is user-defined.

18. The method as recited in claim 16 wherein said wirelessly transmitting and said subsequently automatically deleting are repeated until said detected value falls below said threshold value.

19. The method as recited in claim 15 wherein said wirelessly transmitting and said subsequently automatically deleting are automatically repeated in predetermined time intervals.

20. The method as recited in claim 19 wherein said predetermined time intervals are user-defined.

21. The method as recited in claim 16 wherein said detecting is automatically repeated in predetermined time intervals.

22. The method as recited in claim 21 wherein said predetermined time intervals are user-defined.

23. The method as recited in claim 15 wherein said wirelessly transmitting and said subsequently automatically deleting are automatically performed each time image data is captured and stored.

24. The method as recited in claim 16 wherein said step of detecting is automatically performed each time image data is captured and stored.

25. The method as recited in claim 15 wherein said wirelessly transmitting and said subsequently automatically deleting are performed in response to a user request.

26. The method as recited in claim 16 wherein said detecting is performed in response to user request.

27. The method as recited in claim 16 wherein said detected value is a fraction of a capacity of said memory unit presently used for storing image data.

28. The method as recited in claim 16 wherein said detected value is a fraction of a capacity of said memory unit presently available for storing image data.

29. The method as recited in claim 16 wherein said detected value is a number of images stored in said memory unit.

30. The method as recited in claim 15 wherein said wirelessly transmitting comprises:
generating an MMS-standard multimedia message including said selected digital image data; and
automatically transmitting said MMS-standard multimedia message to a predetermined wireless device.

31. The method as recited in claim 15 wherein said wirelessly transmitting comprises:
generating an e-mail message including said selected digital image data; and
automatically sending said e-mail message to a predetermined e-mail address.

32. The method as recited in claim 15 wherein said wirelessly transmitting comprises uploading said selected digital image data to a web service.

33. The method as recited in claim 15 further comprising:
storing a capture time together with said captured image data in said memory unit; and
selecting said selected digital image data based on said capture time.
